(19) United States
(12) Patent Application Publication
(10) Pub. No.: US 2013/0083210 A1
(43) Pub. Date: Apr. 4, 2013

(54) SCREEN AND WEBCAM VIDEO CAPTURE TECHNIQUES

(71) Applicants: Charles BECKHAM, Redwood City, CA (US); Elizabeth STYLES, Livermore, CA (US); Justin ROWE, San Jose, CA (US); Alexey YARMOLENKO, Saint Petersburg (RU); Alexander FINN, Saint Petersburg (RU); Michael Carl FRISINO, San Mateo, CA (US)

(72) Inventors: Charles BECKHAM, Redwood City, CA (US); Elizabeth STYLES, Livermore, CA (US); Justin ROWE, San Jose, CA (US); Alexey YARMOLENKO, Saint Petersburg (RU); Alexander FINN, Saint Petersburg (RU); Michael Carl FRISINO, San Mateo, CA (US)

(73) Assignee: SUCCESSFACTORS, INC., San Mateo, CA (US)

(21) Appl. No.: 13/526,374

(22) Filed: Jun. 18, 2012

Related U.S. Application Data
(60) Provisional application No. 61/541,960, filed on Sep. 30, 2011.

(51) Int. Cl. H04N 5/225

(52) U.S. Cl. 348/207.11; 348/E05.024

(57) ABSTRACT

A computer-implemented method for recording a video and transmitting the video to a web server via a computing device. The method comprises the steps of, within a web browser, executing both a webcam widget and a micro server applet, wherein the webcam widget is configured to capture the video and stream the video to the micro server applet, recording, by the micro server applet, video streamed from the webcam widget, compressing, by the micro server applet, the streamed video, and transmitting, via the micro server applet, the compressed video to the web server.

### CROSS-REFERENCE TO RELATED APPLICATIONS

This application claims priority benefit to United States provisional patent application titled, “SCREEN AND VIDEO CAPTURE FOR FORMAL AND INFORMAL LEARNING,” filed on Sep. 30, 2011, having application Ser. No. 61/541,960 (Attorney Docket Number SFSF/0012USL), and is incorporated by reference herein.

### BACKGROUND

1. Technical Field

Embodiments of the invention generally relate to video and, more specifically, to screen and webcam video capture techniques.

2. Description of the Related Art

In recent years there has been a proliferation of videos that are available to users via the Internet. The videos can be viewed by users via video sharing websites. Screen capture videos can be created according to a variety of techniques, but most typically require that the user manually installs software on his or her computer configured to record the display output to the computer monitor and record audio data via a microphone. Webcam videos may be created using a variety of techniques, but, like screen capture videos, typically require the user to install software compatible with a specific webcam attached to the computer. Unfortunately, neither approach is ideal since various issues often occur when installing the software, including compatibility issues, licensing fees, and the like.

A more relevant issue is that recorded video may be in a format that is incompatible with a video sharing website to which the user prefers to upload his or her videos. For example, the user may be required to select a video format for the video from a list of video formats that are understood by the software. If the selected video format is not compatible with the video sharing website, then the video cannot be properly uploaded or viewed via the video sharing website. Consequently, the individual is faced with the task of re-recording the video in a different format or converting the recorded video to the different format, which is cumbersome.

As the foregoing illustrates, what is needed in the art is a more effective way to record and share videos.

### SUMMARY

One embodiment includes a method for recording a video uploaded to a web server via a computing device. The method involves, within a web browser, executing both a webcam widget and a micro server applet, wherein the webcam widget is configured to capture the video and stream the video to the micro server applet, recording, by the micro server applet, video streamed from the webcam widget, compressing, by the micro server applet, the streamed video, and uploading, via the micro server applet, the compressed video to the web server.

Another embodiment includes a method for recording a screen capture video and transmitting the screen capture video to a web server via a computing device. This method may include executing within a web browser a screen capture applet. The screen capture applet is configured to capture the screen capture video and stream the screen capture video to a web server. This method may also include compressing, by the screen capture applet, the screen capture video and transmitting, via the screen capture applet, the compressed video to the web server.

Further embodiments provide a non-transitory computer-readable medium and a computer system to carry out the methods set forth above.

### BRIEF DESCRIPTION OF THE DRAWINGS

So that the manner in which the above recited features of the present invention can be understood in detail, a more particular description of the present invention, briefly summarized above, may be had by reference to embodiments, some of which are illustrated in the appended drawings. It is to be noted, however, that the appended drawings illustrate only typical embodiments of the present invention and are therefore not to be considered limiting of its scope, for the present invention may admit to other equally effective embodiments.

FIG. 1 illustrates a networked computer environment in which embodiments of the invention may be practiced.

FIGS. 2A-2F depict example diagrams of a user interface (UI) for recording and uploading a screen capture video, according to embodiments of the present invention.

FIG. 3 is a flow diagram of method steps for recording and uploading a screen capture video, according to one embodiment of the present invention.

FIGS. 4A-4D depict example diagrams of a user interface for recording and uploading a webcam video, according to embodiments of the present invention.

FIG. 5 is a flow diagram of method steps for recording and uploading a webcam video, according to one embodiment of the present invention.

### DETAILED DESCRIPTION

In the following description, numerous specific details are set forth to provide a more thorough understanding of embodiments of the invention. However, it will be apparent to one of skill in the art that embodiments may be practiced without one or more of these specific details. In other instances, well-known features have not been described in order to avoid obscuring embodiments of the present invention.

As is described herein, embodiments of the invention enable a user to record and upload either a screen capture video or a webcam video without being required to manually install specific software. Instead, the user accesses a web browser. Embodiments of the invention also enable the user to preview the video without being required to first upload the video to a remote server, which increases efficiency and enables the user to easily discard and re-record the video, if necessary. Moreover, the remote server is configured to transcode the received video into one or more video formats that are compatible with popular software video players or video sharing websites.

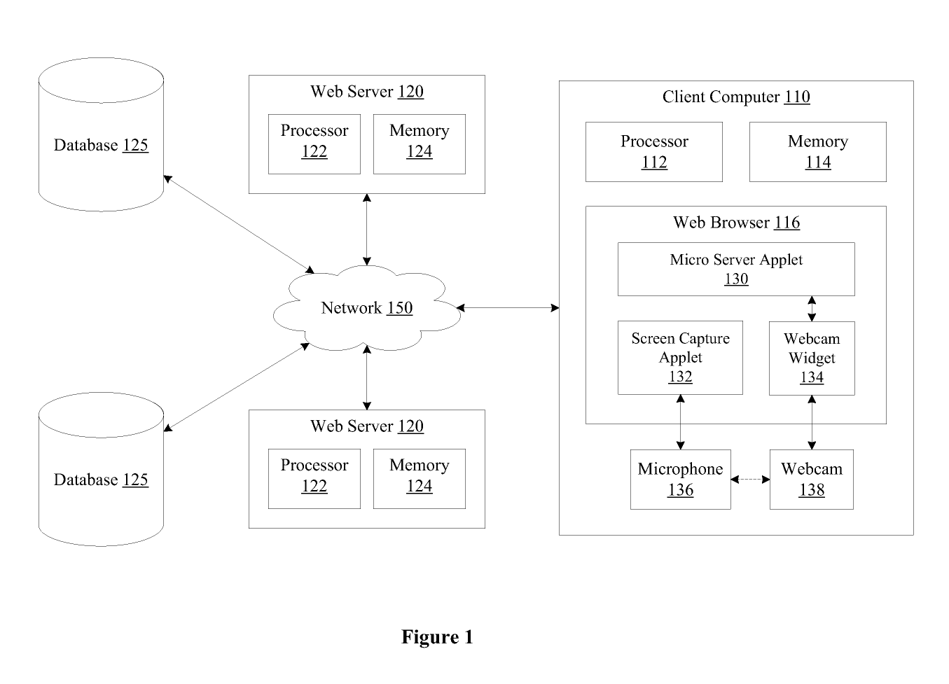

FIG. 1 illustrates a networked computer environment in which embodiments of the invention may be practiced. As shown, the networked computer environment includes a client computer 110, web servers 120, and databases 125. The client computer 110, the web servers 120, and databases 125 are connected to one another over a computer network 150, e.g., the Internet.

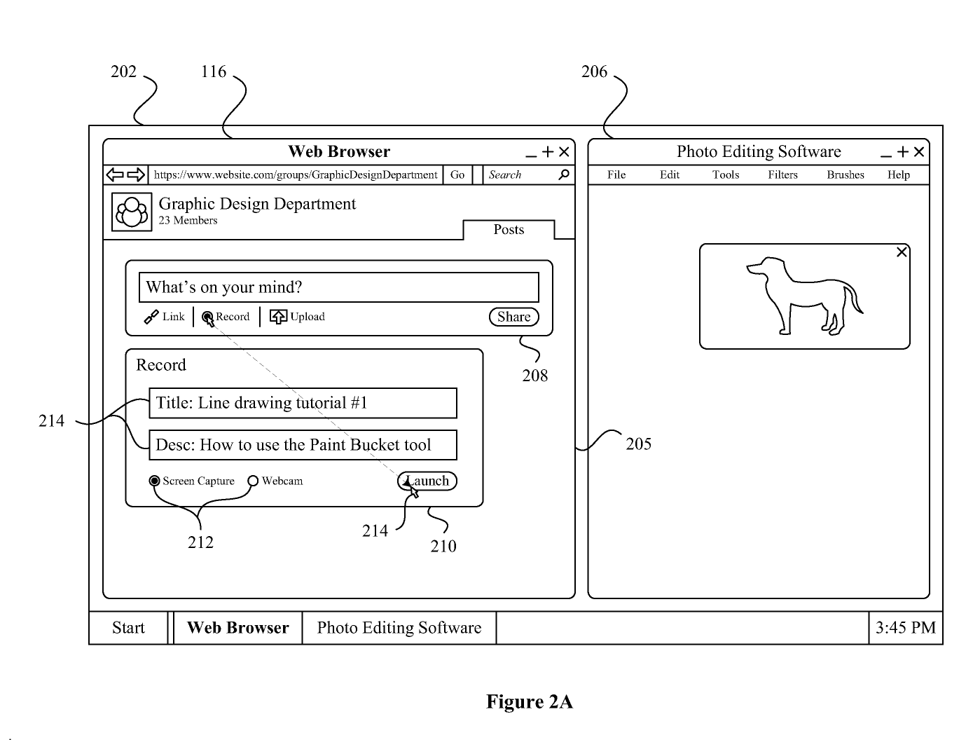

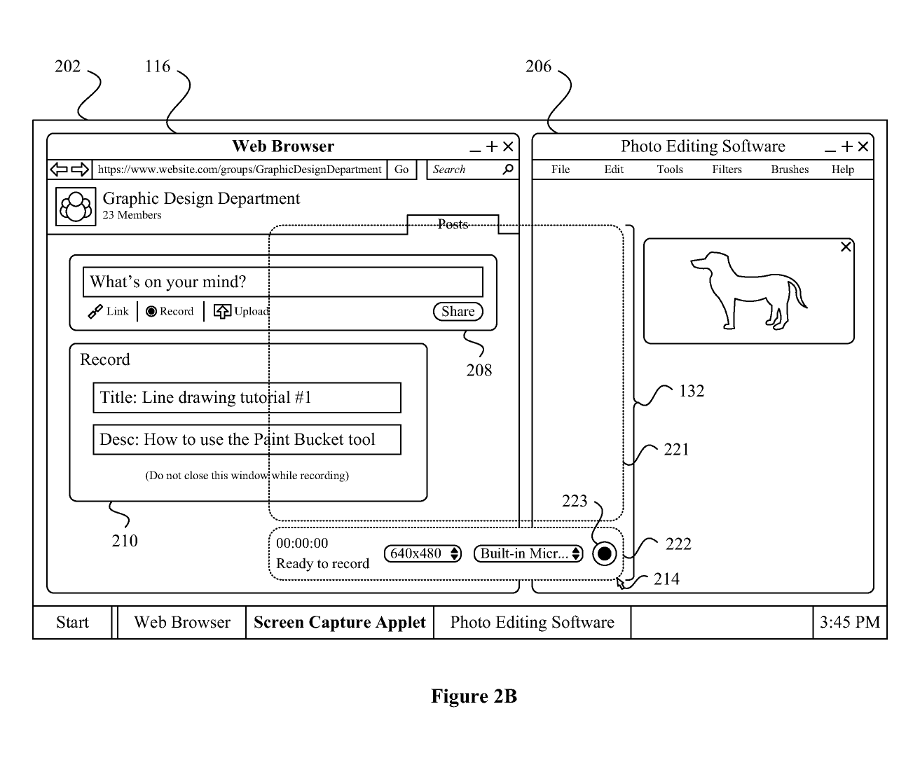

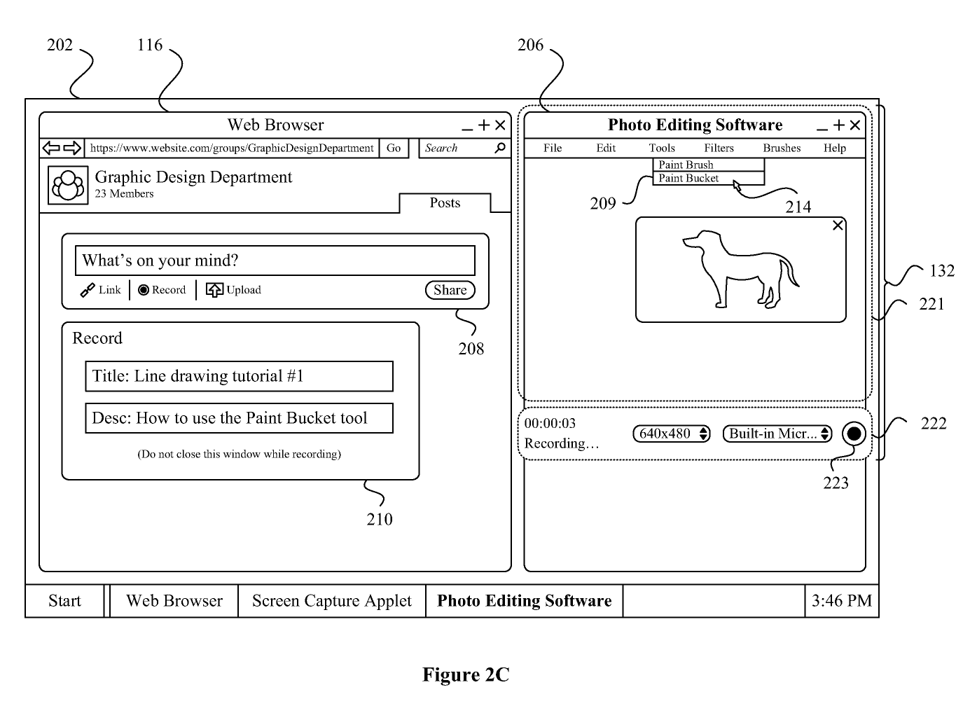

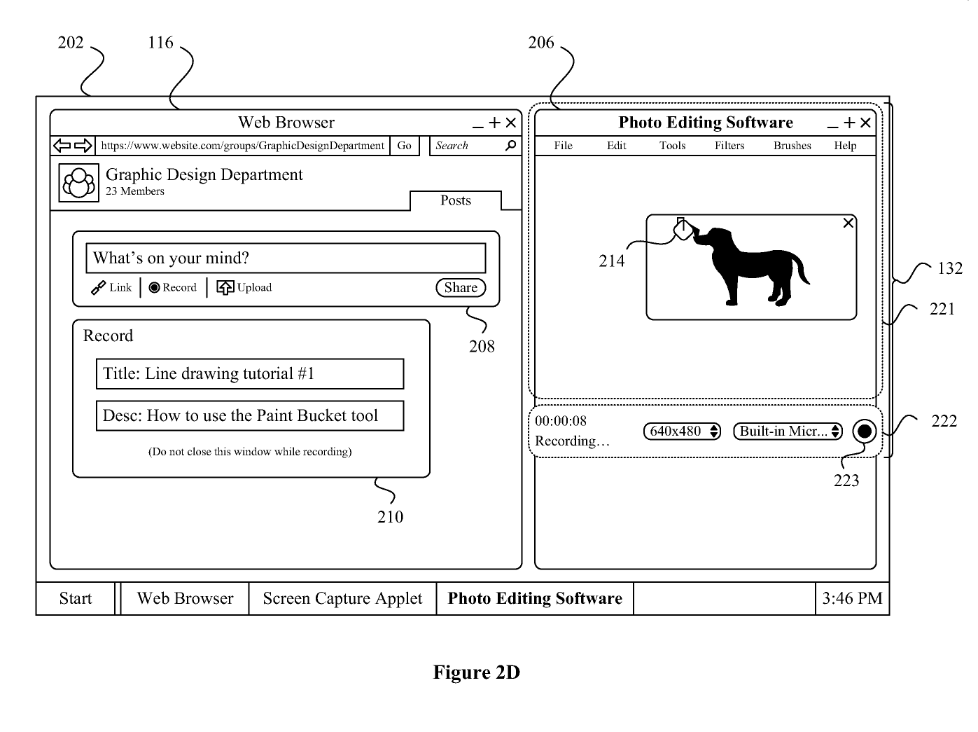

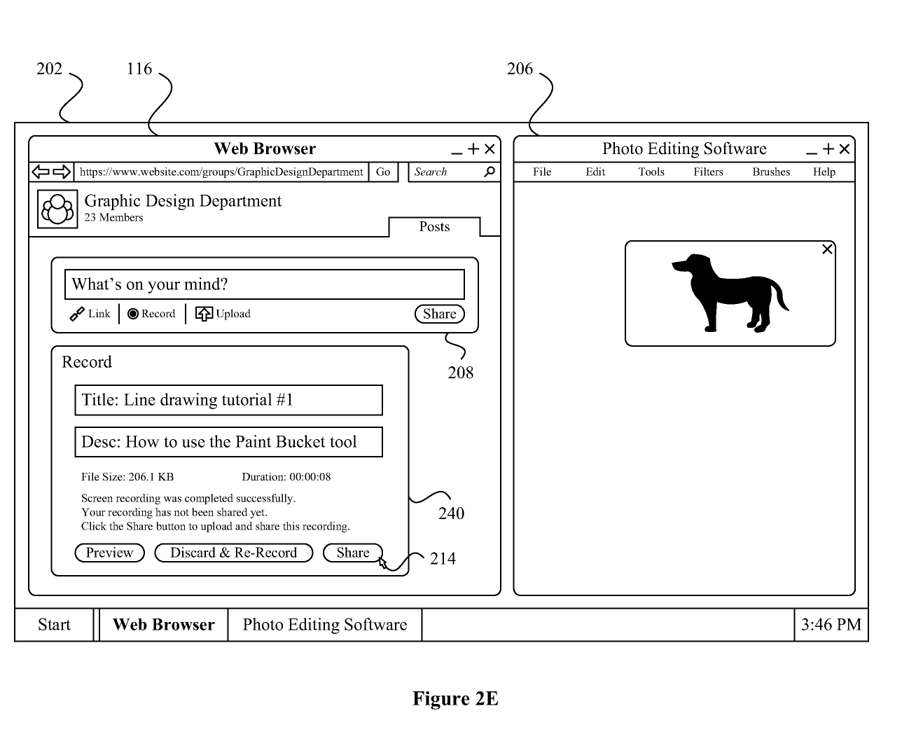

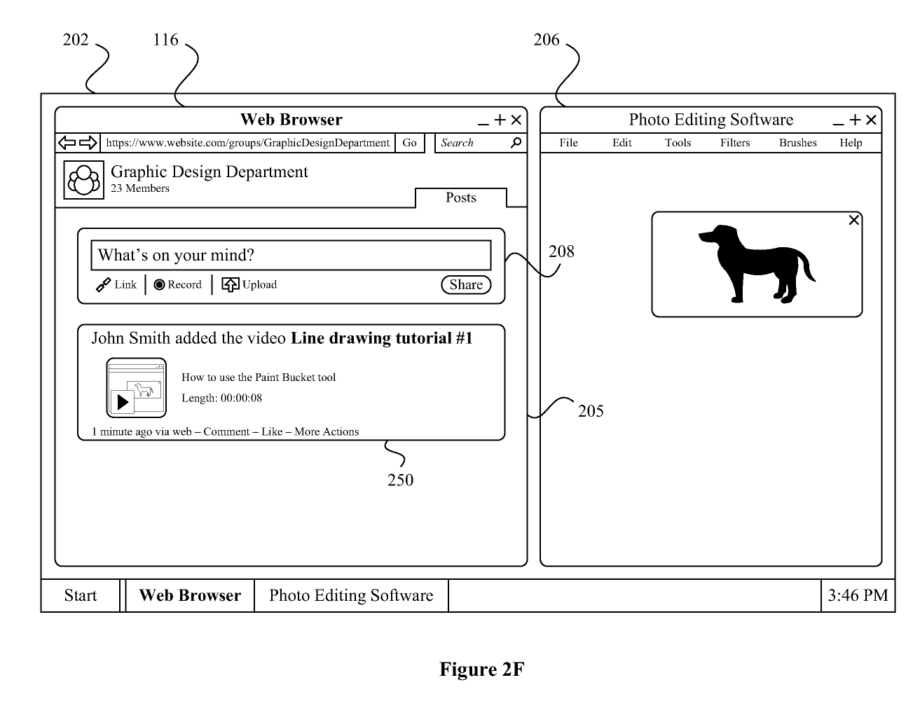

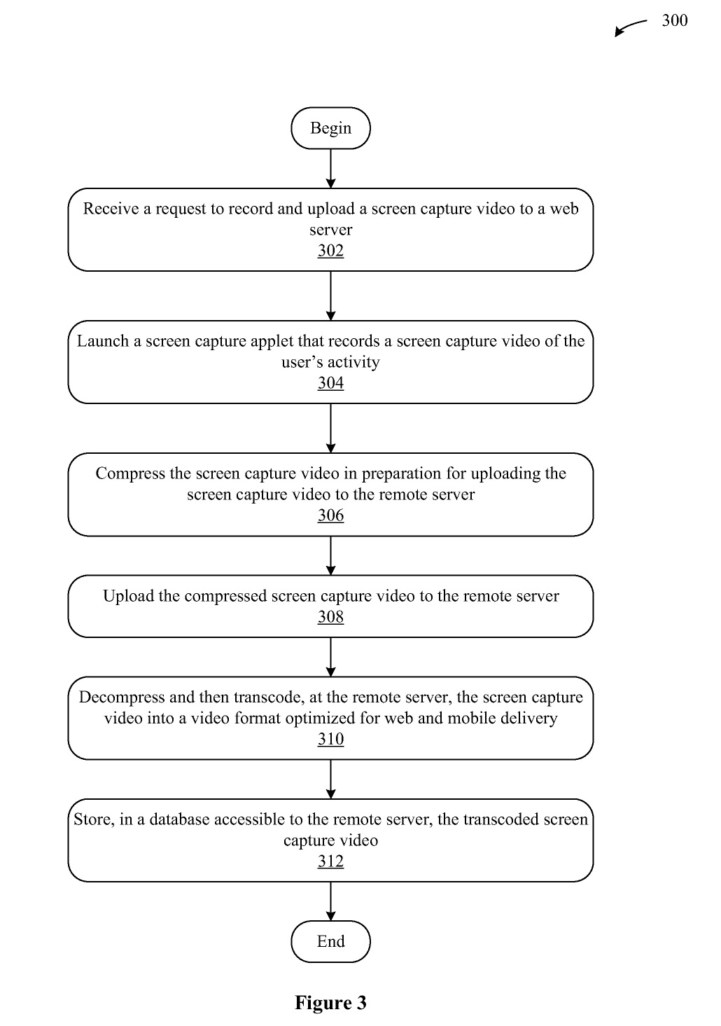

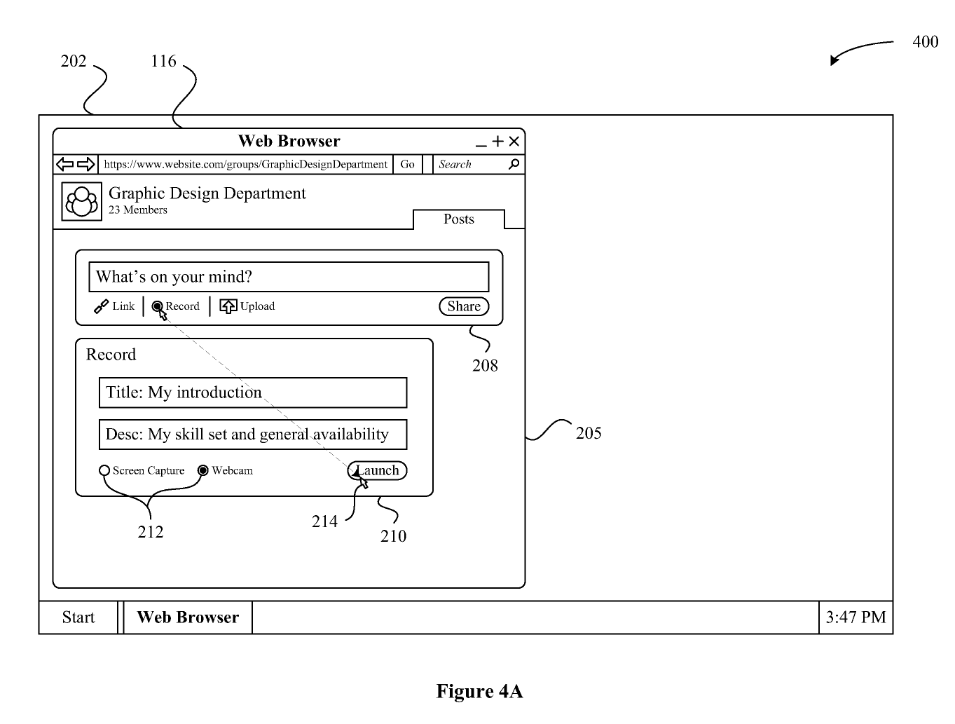

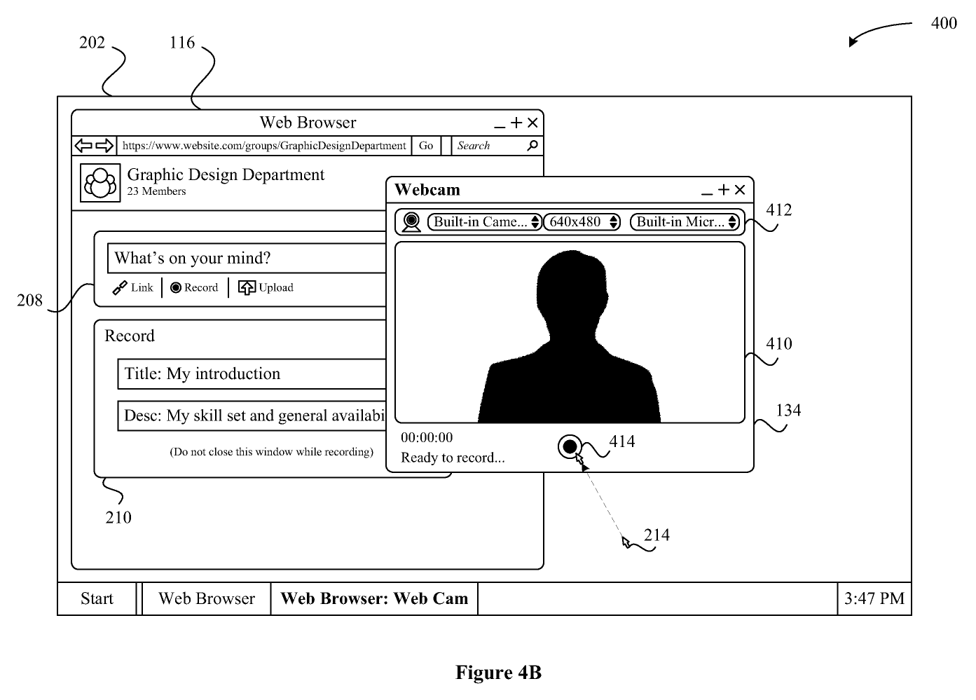

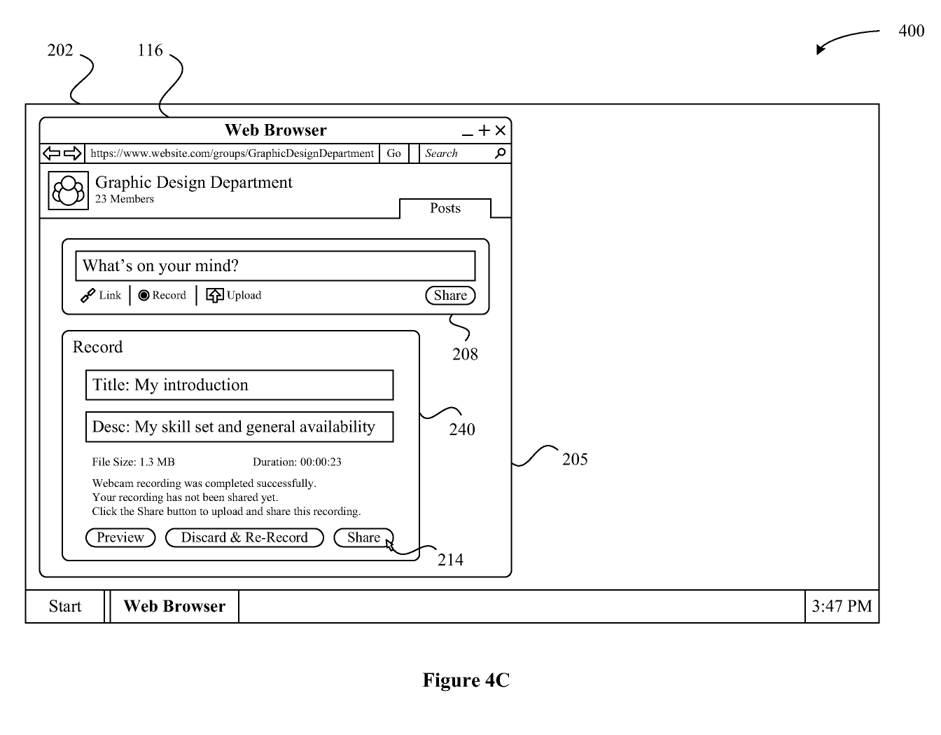

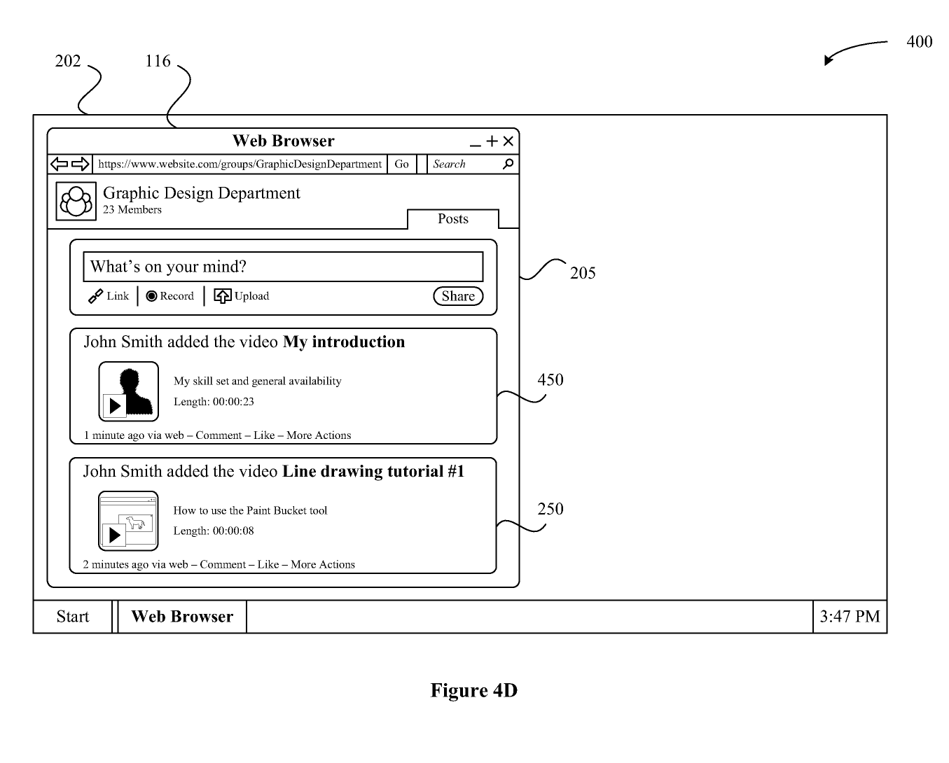

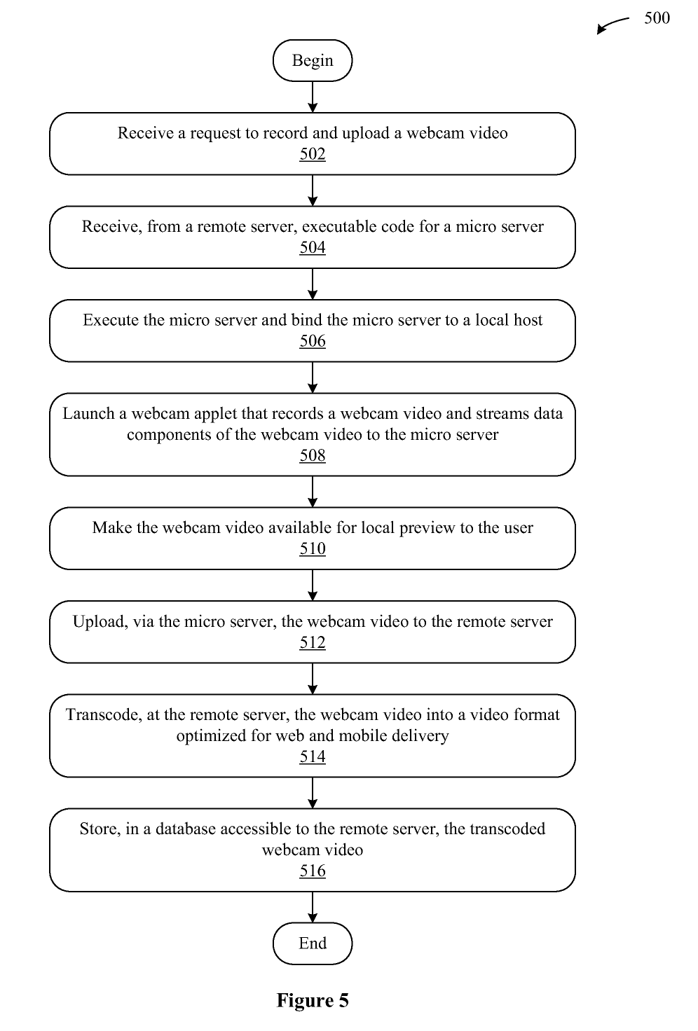

The client computer 110 includes conventional components of a computing device, e.g., a processor 112, system memory 114, a persistent storage device, input devices such as a mouse and a keyboard, and output devices such as a monitor, among others. The client computer 110 is configured to execute web browser 116 and access web pages and/or applications managed by the web servers 120. As described herein, the web browser 116 enables a user of the client computer 110 to either record a screen capture video or record a webcam video and upload the recorded video to web servers 120 for sharing with other users across the Internet. If the user chooses to record a screen capture video, then the web browser 116 downloads to the client computer 110 both a screen capture applet 132 and a micro server applet 130, the functionalities of which are described below in conjunction with FIGS. 2A-2F and FIG. 3. In this scenario, the web browser 116 executes the screen capture applet 132 as a first child process (e.g., in a pop-up window) and executes the micro server applet 130 as a second child process. In this way, the screen capture applet 132 and the micro server applet 130 are able to communicate with one another to provide the techniques described herein. Alternatively, if the user chooses to record a webcam video, then the web browser 116 downloads to the client computer 110 both a webcam widget 134 and the micro server applet 130, the functionalities of which are described below in conjunction with FIGS. 4A-4D and FIG. 5. In this scenario, the web browser 116 executes the webcam widget 134 as a first child process (e.g., a pop-up window) and executes the micro server applet 130 as a second child process.

As shown, a microphone 136 is attached to the client computer 110. The microphone 136 captures accompanying audio data for a screen capture video and/or webcam video being recorded. The client computer 110 also has attached thereto a webcam 138 for capturing video data when recording a webcam video. In some cases, the webcam 138 and the microphone 136 are integrated within a single device.

Each web server 120 includes a processor 122 and a system memory 124. In one embodiment, each web server 120 is associated with a corresponding database 125 and manages the contents stored in the database 125. The web servers 120 are programmed to communicate with the client computers 110, the databases 125, and other web servers 120 via the computer network 150 using a network protocol, e.g., the TCP/IP protocol or the HTTP protocol. Any number of web servers 120 may be employed by embodiments of the present invention, including only a single web server 120.

In the embodiments described below, a user manipulates the client computer 110 connected to the web servers 120 over the computer network 150. In one embodiment, the web server 120 transmits user interfaces in the form of web pages to the client computer 110. The web browser program 116 executing on the client computer 110 then processes the web pages for display through a display device attached to the client computer 110.

The client computer 110 may be a personal computer, smart phone, tablet computer, or any other device suitable for practicing one or more embodiments of the present invention. It should be noted that embodiments of the present invention can be implemented in hardware, software, or in a combination of hardware and software, e.g., using application specific integrated circuits (ASIC), a general purpose computer, or any other hardware equivalents.

As set forth above, conventional techniques for recording and uploading both screen capture videos and webcam videos require users to perform a cumbersome software installation process. Accordingly, embodiments of the invention enable a user to record both screen capture videos and webcam videos via the web browser 116 without requiring the user to first perform a manual software installation process. Moreover, embodiments of the invention provide the user with a seamless transition between recording a video and uploading the video to the internet for others to view, which enhances the overall user experience. As described, the details of recording and uploading screen capture videos are described below in conjunction with FIGS. 2A-2F and FIG. 3, and the details of recording and uploading webcam videos are described below in conjunction with FIGS. 4A-4D and FIG. 5.

FIGS. 2A-2F depict example diagrams of a user interface for recording and uploading a screen capture video, according to embodiments of the present invention. Some features shown are not necessarily present in every embodiment. FIG. 2A depicts a graphical user interface (GUI) 202 that is generated by an operating system (OS) executing on the client computer 110. As shown, the operating system is executing web browser 116 and, additionally, a photo editing software program 206. In the example illustrated in FIG. 2A, the web browser 116 is displaying a web page 205 that is provided by a business execution software provider, such as SuccessFactors, Inc. located in San Mateo, Calif., and hosted by one or more web servers 120. For example, the web page 205 may enable online social networking between members of a Graphic Design Department of a company. As shown, the web page 205 includes a new posting area 208 that enables a user to share information with the members of the Graphic Design Department, such as text-based messages, links to webpages, files (such as photos), and the like.

The new posting area 208 also enables the user to record and upload a screen capture video or a webcam video. In particular, the new posting area 208 includes a “Record” button that, when selected by the user via a mouse cursor 214, causes the web browser 116 to display the new video recording area 210. As shown, the new video recording area 210 enables the user to record either a screen capture video or a webcam video by selecting one of the radio buttons 212. The new video recording area 210 also enables the user to submit, via text boxes 214, a title, e.g., “Line drawing tutorial #1” and a description, e.g., “How to use the Paint Bucket tool,” for the screen capture video that the user intends to record and share with the other members of the Graphic Design Department.

Once the user enters the appropriate identifying information for the video to be recorded (e.g., title and description), the user selects the “Launch” button. Selecting the Launch button causes the web browser 116 to load the screen capture applet 132, an illustration of which is included in FIG. 2B. In one embodiment, the screen capture applet 132 is implemented using a Java® Applet that the web browser 116 downloads from a web server 120 and executes locally on the client computer 110. The screen capture applet 132, when loaded, accesses resources of the client computer 110, which may include both display data and mouse cursor data that are output by the operating system executing on the client computer 110, as well as audio data collected by the microphone 136. This data is subsequently processed by the micro server applet 130 and the web servers 120 to produce a screen capture video, the details of which are described below in conjunction with FIG. 3.

In one embodiment, the screen capture applet 132 references a low-level application programming interface (API) that does not perform color conversion when sampling the display data, which may reduce processor overhead for processor 112 included in the computing device 110. In one embodiment, the screen capture applet 132 is configured to communicate with the web browser 116 and web page 205 via Javascript code. Such communication involves, for example, the screen capture applet 132 indicating to the web browser 116 that the user has ended his or her recording of the screen capture video and that the micro server applet 130 should prepare to upload the screen capture video to the web servers 120.

As shown in FIG. 2B, the screen capture applet 132 includes a recording area 221 and a settings area 222. The settings area 222 enables the user to view a status of the screen capture recording (e.g., ready to record, recording, etc.). The settings area 222 also enables the user to select from a list of recording resolutions (e.g., 640×480 pixels, 800×600 pixels, etc.). The size of the recording area 221 is adjusted accordingly when a selection of a recording resolution is made by the user. The user may also adjust the size of the recording area 221 to a custom setting that is not included in the list of recording resolutions. The settings area 222 further enables the user to select a microphone from which audio data is recorded if two or more microphones are attached to the client computer 110. Additionally, a record button 223 enables the user to start and stop the screen capture recording.

As shown in FIG. 2B, the recording area 221 may be transparent, allowing the user to view the area of GUI 202 recorded by the screen capture applet 132. The perimeter of the recording area 221 is selectable via the mouse cursor 214 and enables the user to resize and move the recording area 221 to overlap the area of the GUI 202 that the user desires to record. Moreover, the recording area 221 is capable of recording across multiple displays when two or more monitors are attached to the client computer 110.

FIG. 2C illustrates the screen capture applet 132 after the screen capture applet 132 is relocated to overlap a portion of the photo editing software program 206 and after the record button 223 is selected by the user. In the example illustrated in FIG. 2C, the user begins his or her activity by navigating through a menu 209 included in the photo editing software program 206 and selecting the “Paint Bucket” item from the “Tools” category in the menu 209. As described above, audio data, such as the user's commentary, and mouse cursor data are collected by the screen capture applet 132 in addition to collecting the display data within the recording area 221.

In FIG. 2C, the photo editing software program 206 includes a line drawing of a dog that the user wishes to modify. FIG. 2D illustrates the user continuing his or her activity and updating the fill color of the dog line drawing. When the user finishes his or her activity, the user selects the recording button 223 again to stop the screen capture recording. In turn, the web browser 116 displays to the user a video review/upload form 240, which is illustrated in FIG. 2E.

As shown in FIG. 2E, the video review/upload form 240 enables the user to preview the screen capture video recorded by the screen capture applet 132, to discard the recorded screen capture video and record a new screen capture video, and/or to share the screen capture video by posting the screen capture video for the other members of the Graphic Design Department to view. As also shown, the video review/upload form 240 enables the user to edit the title and description of the screen capture video, and displays both a file size and a duration of the screen capture video.

The user can then select the “Share” button included in the video review/upload form 240. In response, the micro server applet 130 uploads the screen capture video to a web server 120. As shown in FIG. 2F, when the upload is complete, the web browser 116 updates the web page 205 to include a posting 250 for the screen capture video uploaded by the user. The posting 250 displays a thumbnail of the uploaded screen capture video, the title and the description of the uploaded screen capture video, and hyperlinks that enable the viewers thereof to perform a variety of actions associated with the uploaded screen capture video, such as posting comments.

FIG. 3 is a flow diagram of method steps 300 for recording and uploading a screen capture video, according to one embodiment of the present invention. Although the method steps are described in conjunction with FIGS. 1 and 2A-2F, persons skilled in the art will understand that any system configured to perform the method steps, in any order, is within the scope of embodiments of the present invention. The steps illustrated in FIG. 3 may be combined, modified, or deleted where appropriate. Additional steps may also be added to the method.

As shown, the method 300 begins at step 302, where the web browser 116 receives a request to record and upload a screen capture video to web server 120. The request is received according to the techniques described above in conjunction with FIG. 2A.

At step 304, the web browser 116 launches the screen capture applet 132 to enable the user to record a screen capture video of his or her activity on the client computer 110. The screen capture applet 132 captures components of the screen capture video, which, again, include display data output by the operating system executing on the client computer 110, mouse cursor data output by the operating system executing on the client computer 110, and audio data output by a microphone device. In one embodiment, the mouse cursor data is sampled at a different frame rate than the display data. In one example, the screen capture applet 132 is configured to sample the mouse cursor data at ten frames per second and to sample the display data at three frames per second. In some cases, the screen capture applet 132 is configured to dynamically adjust the aforementioned sampling rates according to the performance abilities of the client computer 110, e.g., processor speed, available random access memory (RAM), and the like, which the screen capture applet 132 obtains through the low-level API described above in conjunction with FIG. 2A.

At step 306, the screen capture applet 132 compresses the components of the screen capture video (i.e., display output data, mouse cursor data, and audio data) in preparation for uploading the screen capture video to the web server 120. In one embodiment, the screen capture applet 132 is configured to calculate delta values that correspond to a difference between frames of display data, whereupon the delta values are compressed using Run-Length Video Encoding (RLE). In some cases, the RLE-based compression is modified to implement non-standard data packing to allow for larger repeating sequences. In particular, standard RLE allows only 7 bits to store a repeating sequence length (127 bytes), whereas, in one embodiment, screen capture applet 132 is configured to implement 15 bits to store a repeating sequence length (32,767 bytes). The increased repeating sequence length provides for an increased compression ratio when working with long sequences of repeating bytes, which is frequently observed in screen capture videos since video frames included therein have a strong similarity to one another. For example, if a user clicks on a menu within an application, only about 10% of screen area is typically changed, whereas the other 90% remains intact.

In some cases, screen capture applet 132 is configured to perform an additional compression of the delta values (that are already compressed according to the modified RLE-based compression) based on the Lempel-Ziv-Welch (LZW) compression algorithm. Thus, the delta values are first compressed using RLE-based compression, and then further compressed using the LZW compression algorithm. In one embodiment, the audio data is captured in a 44.100 Hz/16-bit/Stereo format, and the micro server applet 130 is configured to compress the audio data using Vorbis® technology. Importantly, the foregoing compression techniques are both lossless compression techniques, which prevent any degradation to the quality of the screen capture video from occurring, although lossy compression techniques may be used as well.

When the double-compression of the display data and the single compression of the audio data is completed according to the foregoing techniques, the screen capture applet 132 interleaves the doubly-compressed display data, the compressed audio data, and the mouse cursor data into one bitstream, where each substream in the bitstream includes a header to store metadata associated with the substream.

At step 308, the screen capture applet 132 uploads the compressed screen capture video to the web server 120. In one embodiment, the screen capture applet 132 is configured to upload the compressed screen capture video to the web server 120 using HTTP.

At step 310, after receiving the screen capture video, the web server 120 decompresses and transcodes the screen capture video, e.g., into a video format that is optimized for web and/or mobile delivery. In one embodiment, the web server 120 decompresses the screen capture video and extracts the display data, the mouse cursor data, and the audio data of which the screen capture video is composed. Subsequently, the web server 120 processes the display data, the mouse cursor data, and the audio data to produce a screen capture video in a popular video format, e.g., “.avi” or “.mpeg”. In one embodiment, the web server 120 is configured to, when producing the screen capture video, interpolate the mouse cursor data to produce a higher mouse cursor frame rate than the frame rate at which the mouse cursor was originally sampled, which enhances the smoothness of the mouse cursor movement when playing back the transcoded screen capture video.

At step 312, the web server 120 stores, in a database 125 accessible to the web server 120, the transcoded screen capture video. In this way, the web servers 120 are able to deliver the screen capture video to other users who are interested in viewing the screen capture video via, for example, a web browser, or by downloading the screen capture video for local storage and playback.

As described above, embodiments of the invention additionally enable a user to record and upload webcam videos. FIGS. 4A-4D depict example diagrams 400 of a user interface for recording and uploading a webcam video, according to embodiments of the present invention. FIG. 4A depicts the GUI 202 on the client computer 110. As shown, the web browser 116 has rendered the web page 205. In the example illustrated in FIG. 4A, the user selects the “Record” button included in the new posting area 208, and then selects the “Webcam” option made available through the radio buttons 212. The user inputs a title for the webcam video (e.g., “My introduction”) and also inputs a description for the webcam video (e.g., “My skill set and general availability”).

When the user is satisfied with the information submitted into the new video recording area 210, the user selects the “Launch” button included in the new video recording area 210. Selecting the “Launch” button causes the web browser 116 to load the webcam widget 134, an illustration of which is included in FIG. 4B. In one embodiment, the webcam widget 134 is implemented using Adobe Flash® technology and is downloaded by the web browser 116 from the web servers 120 and executed locally on the client computer 110. The webcam widget 134, when loaded, communicates with the webcam 138 attached to the client computer 110. The webcam widget 134 is configured to collect video data and audio data from the webcam 138 to produce a webcam video. The webcam video is subsequently uploaded to the web servers 120 by the micro server applet 130 for sharing with other users. The webcam widget 134, like the screen capture applet 132, is configured to communicate with the web browser 116 and/or web page 205 via Javascript code.

As shown in FIG. 4B, the webcam widget 134 comprises a webcam feed area 410, a settings area 412, and a record button 414. The webcam feed area 410 displays a video feed that is captured by the webcam 138. The settings area 412 enables the user to select a webcam to record video data when two or more webcams are attached to the client computer 110. The settings area 412 also enables the user to select from a list of recording resolutions that are compatible with the webcam 138. The settings area 412 also enables the user to select a microphone to record audio data if two or more microphones are attached to the client computer 110. The record button 414 enables the user to start and stop the webcam video recording. Additionally, the webcam widget 134 displays to the user a status of the webcam recording (e.g., ready to record, recording, etc.), along with a duration of the webcam video that has been recorded so far.

As shown in FIG. 4B, the user selects the record button 414 using the mouse cursor 214, which causes the webcam widget 134 to record the audio/video output from the webcam 138 and stream the audio/video output to the micro server applet 130, the details of which are described below in conjunction with FIG. 5. FIG. 4C illustrates the video review/upload form 240, which is displayed to the user after the user ends the webcam recording.

As shown in FIG. 4C, the video review/upload form 240 enables the user to either preview the webcam video that was recorded by the webcam widget 134, to discard the recorded webcam video and record a new webcam video, and/or to share the webcam video by posting the webcam video to the web page 205 for other users to view. As with screen capture videos, the video review/upload form 240 enables the user to edit the title and description of the webcam video, and displays both a file size and a duration of the webcam video. The user can then select the “Share” button included in the video review/upload form 240, which causes the micro server applet 130 to upload the webcam video to a web server 120.

As shown in FIG. 4D, when the upload is completed, the web browser 116 updates the web page 205 to include a posting 450 for the webcam video. The posting 450 for the uploaded webcam video displays a thumbnail of the uploaded webcam video, the title and the description of the uploaded webcam video, and hyperlinks that enable users to perform a variety of actions associated with the webcam video, such as posting comments. FIG. 4D also illustrates the posting 250 from FIG. 2F, which corresponds to the screen capture video recorded and uploaded by the user according to the techniques described above in conjunction with FIGS. 2A-2F.

FIG. 5 is a flow diagram of method steps 500 for recording and uploading a webcam video, according to one embodiment of the present invention. Although the method steps are described in conjunction with FIGS. 1, 2A-2F, 3 and 4A-4D, persons skilled in the art will understand that any system configured to perform the method steps, in any order, is within the scope of embodiments of the present invention.

As shown, the method 500 begins at step 502, where the web browser 116 receives a request to record and upload a webcam video. This request is received, e.g., according to the techniques described above in conjunction with FIG. 4A.

At step 504, the web browser 116 receives, from the web server 120, executable code for the micro server applet 130. In one embodiment, the micro server applet 130 is implemented using Real Time Messaging Protocol (RTMP) technology, and is referred to as “micro” server applet 130 due to only using a limited set of functionality provided by RTMP technology, which may include handshaking commands to establish communication between the screen capture applet 132 and the micro server applet 130, data stream chunk size negotiation commands, data stream creation commands, and/or publish commands.

At step 506, the web browser 116 executes the micro server applet 130 and binds the micro server applet 130 to a port address on the client computer 110. In one example, the micro server applet 130 is configured to listen on a particular port of the local host on the client computer (e.g., http://localhost:8080). In this way, applets launched by the web browser 116, e.g., the webcam widget 134, are able to upload webcam video data to the micro server applet 130. Advantageously, bandwidth restrictions, lost packets and proxy configuration requirements may be reduced or even eliminated since the webcam widget 134 locally streams the webcam video data to the micro server applet 130 within the client computer 110.

At step 508, the web browser 116 launches the webcam widget 134 to enable the user to record a webcam video. In one embodiment, the webcam widget 134 is implementing using Adobe Flash technology, which creates and records the webcam video in the “.flv” format. The webcam widget 134 is configured to stream the components of the webcam video to the micro server applet 130 via the local host on the client computer 110.

At step 510, the micro server applet 130, under control of the web browser 116, makes the webcam video available for local preview to the user. In one embodiment, the micro server applet 130 implements the hypertext transfer protocol (HTTP) to monitor a dynamically-established port for HTTP requests made by the webcam widget 134 to preview the webcam video. In response to the HTTP requests, the micro server applet 130 either transmits the webcam video back to the webcam widget 134 for playback, or an extended markup language (XML) file that, when received by the webcam widget 134, enables the webcam widget 134 to access the webcam video via the micro server applet 130.

At step 512, the micro server applet 130 uploads the webcam video to the web server 120. In one embodiment, the micro server applet 130 is configured to upload the webcam video to the web server 120 using the hypertext transfer protocol (HTTP), where the webcam video is uploaded as HTTP multipart form-data. In some embodiments, the micro server applet 130 is configured to compress the webcam video prior to uploading the webcam video to the web server 120. In addition to uploading the webcam video, the micro server applet 130 may also upload metadata items, such as a description of the webcam video and an identification (ID) for the webcam video for organizational purposes.

At step 514, the web server 120, after receiving the webcam video, transcodes the webcam video into a video format optimized for web and/or mobile delivery. In one embodiment, the web server 120 extracts the audio data and the video data from the stream received from the micro server applet 130. Subsequently, the web server 120 processes the audio data and the video data to produce a webcam video in a popular format, e.g., “.avi” or “.mpeg”.

At step 516, the web server 120 stores the transcoded webcam video in the database 125. In this way, each of the web servers 120 are able to deliver the webcam video to users interested in viewing the webcam video via, for example, a browser, or by downloading the webcam video for local storage and playback.

In sum, embodiments of the invention enable a user to record and upload either a screen capture video or a webcam video without being required to manually install specific software. Instead, the user accesses a web browser. Embodiments of the invention enable the user to preview the video without being required to first upload the video to a remote server, which increases efficiency and enables the user to easily discard and re-record the video, if necessary. Moreover, the remote server is configured to transcode the received video into one or more video formats that are compatible with popular software video players or video sharing websites.

Transcoding the received video by the remote server and not by the micro server provides various advantages. One advantage is that the heavyweight process of transcoding a video is handled by one or more remote servers, which are typically more powerful than consumer computers. In this way, the amount of time that is required to transcode the video may be significantly reduced, which correspondingly reduces the typical delay that the user experiences before being able to share his or her video across the internet. Another advantage is that the remote servers are not operating under the constraints of the web browser, which allows the remote servers to execute virtually any software that is configured to transcode videos. In this way, the remote servers may be capable of transcoding the video into any popular video format.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips, or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A computer-implemented method for recording a webcam video and transmitting the webcam video to a web server via a computing device, the method comprising:
executing within a web browser both a webcam widget and a micro server applet, wherein the webcam widget is configured to capture the webcam video and stream the webcam video to the micro server applet;
recording, by the micro server applet, video streamed from the webcam widget;
compressing, by the micro server applet, the streamed video; and
transmitting, via the micro server applet, the compressed video to the web server.

2. The method of claim 1, wherein the webcam video includes video frame data and audio data captured via a webcam device attached to the computing device.

3. The method of claim 2, wherein the frame data includes a video resolution specified via the webcam widget.

4. The method of claim 1, further comprising enabling the webcam widget to play back the webcam video via the micro server applet.

5. The method of claim 1, further comprising:
receiving, by the web server, the compressed video;
decompressing, by the web server, the compressed video;
transcoding the decompressed video into one or more transcoded videos, wherein each of the one or more transcoded videos is based on a different video format; and
storing the one or more different videos.

6. A computer-readable storage medium storing instructions that, when executed by a processor, cause a computer system to record a webcam video and transmit the webcam video to a web server, by performing the steps of:
within a web browser, executing both a webcam widget and a micro server applet, wherein the webcam widget is configured to capture the webcam video and stream the webcam video to the micro server applet;
recording, by the micro server applet, video streamed from the webcam widget;
compressing, by the micro server applet, the streamed video; and
transmitting, via the micro server applet, the compressed video to the web server.

7. The computer-readable storage medium of claim 6, wherein the webcam video includes video frame data and audio data captured via a webcam device attached to the computer system.

8. The computer-readable storage medium of claim 7, wherein the frame data includes a video resolution specified via the webcam widget.

9. The non-transitory computer-readable medium of claim 8, further comprising enabling the webcam widget to play back the webcam video via the micro server applet.

10. The computer-readable storage medium of claim 6, further comprising:
receiving, by the web server, the compressed video;
decompressing, by the web server, the compressed video;
transcoding the decompressed video into one or more transcoded videos, wherein each of the one or more transcoded videos is based on a different video format; and
storing the one or more different videos.

11. A computer system, comprising:
a processor; and
a memory storing instructions that, when executed by the processor, cause the computer system to record a webcam video and transmit the webcam video to a web server, by performing the steps of:
within a web browser, executing both a webcam widget and a micro server applet, wherein the webcam widget is configured to capture the webcam video and stream the webcam video to the micro server applet;
recording, by the micro server applet, video streamed from the webcam widget;
compressing, by the micro server applet, the streamed video; and
transmitting, via the micro server applet, the compressed video to the web server.

12. The system of claim 11, wherein the webcam video includes video frame data and audio data captured via a webcam device attached to the computer system.

13. The system of claim 12, wherein the frame data includes a video resolution specified via the webcam widget.

14. The system of claim 11, further comprising enabling the webcam widget to play back the webcam video via the micro server applet.

15. A computer-implemented method for recording a screen capture video and transmitting the screen capture video to a web server via a computing device, the method comprising:
executing within a web browser a screen capture applet, wherein the screen capture applet is configured to capture the screen capture video and stream the screen capture video to a web server;
compressing, by the screen capture applet, the screen capture video; and
transmitting, via the screen capture applet, the compressed video to the web server.

16. The method of claim 15, wherein the screen capture video includes frames of display data output by an operating system (OS) executing on the computing device that correspond to at least a portion of a user interface (UI), mouse cursor data associated with the UI, and audio data captured via a microphone device that is attached to the computing device.

17. The method of claim 16, wherein the at least a portion of the UI corresponds to a resizable transparent screen capture area.

18. The method of claim 15, wherein the step of compressing involves:
calculating delta values that correspond to a difference between the frames of the display data;
compressing the delta values according to the Run-Length Video Encoding (RLE) compression algorithm; and
compressing the compressed delta values according to the Lempel-Ziv-Welch (LZW) compression algorithm.

19. The method of claim 15, further comprising:
receiving, by the web server, the compressed video;
decompressing, by the web server, the compressed video;
transcoding the decompressed video into one or more transcoded videos, wherein each of the one or more transcoded videos is based on a different video format; and
storing the one or more different videos.
